(19) United States
(12) Patent Application Publication
(10) Pub. No.: US 2007/0136785 A1
(43) Pub. Date: Jun. 14, 2007

(54) Content-based authorization method and apparatus

(75) Inventors: Chandra Warrier, Schaumburg, IL (US); Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/298,549

(22) Filed: Dec. 8, 2005

(51) Int. Cl. H04L 9/32

(52) U.S. Cl. 726/2

(57) ABSTRACT

An Internet Protocol access gateway (200) characterized by having automatically and dynamically maintained end user profile information can receive (101) information (subsequent to otherwise authenticating an end user's ability to engage in a communication session) regarding content being sought by the end user via a communication session. That access gateway can then facilitate determination (102) regarding whether this end user is authorized to receive such content.

### TECHNICAL FIELD

This invention relates generally to Internet Protocol-based communications.

### BACKGROUND

Internet Protocol-based communications of various kinds are known in the art with additional variations being fielded on a regular basis. In many cases an end user platform (including wireless devices such as an Internet Protocol-capable cellular telephone, a Personal Digital Assistant, laptop computers, and so forth) accesses the Internet itself via a corresponding access gateway (such as a Packet Data Serving Node or the like). In many cases such an end user platform must first be authenticated by a corresponding Authentication, Authorization, and Accounting (AAA) element via an authentication protocol such as Remote Authentication Dial-In User Service (RADIUS) or DIAMETER. Once authenticated, such an end user may then use the access gateway to effect Internet Protocol networking in an essentially unfettered manner.

While suitable for many application settings, there are also many usage scenarios where such an approach is partially or wholly inadequate. The typical prior art approach serves, more or less, to ensure only that a given device is authorized to access the Internet (or other network) via the access gateway in question. There are many situations, however, where such access control granularity is too course. As one example, a parent may be content to permit their child to access the Internet to gain access to certain categories of approved content but may strongly wish to deny their child access to other categories of content. As another example, a business enterprise may wish to provide employees with wireless field access to enterprise network resources via a virtual private network but may wish to preclude use of such resources to carry out more personal inquiries and tasks.

Simply denying all network access, or permitting all network access, does not adequately address such needs. This, in turn, can result in discouraging otherwise beneficial and useful platform deployments and application development as network administrators concerned over such matters may chose to simply avoid the problem by not providing the opportunity in the first instance.

### BRIEF DESCRIPTION OF THE DRAWINGS

The above needs are at least partially met through provision of the content-based authorization method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a series of call flow diagrams as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an Internet Protocol access gateway characterized by having automatically and dynamically maintained end user profile information can receive information (subsequent to otherwise authenticating an end user's ability to engage in a communication session) regarding content being sought by the end user via a communication session. That access gateway can then facilitate determination regarding whether this end user is authorized to receive such content.

By one approach the access gateway makes use of one or more local resources to effect this determination. By another approach the access gateway accesses a remote resource to facilitate such a determination. If desired, at least some of the requested content can be acquired and buffered prior to determining that the end user is, in fact, authorized to receive such content. By this approach, the buffered content can be released to the end user immediately upon determining the end user's authorized status.

Also if desired, information corresponding to such a determination can be locally stored. So configured, such local information can be subsequently applied to permit a local and relatively rapid response to a subsequent request by this same end user for identical content. For example, when authorization has been confirmed, a subsequent request for such content can be essentially immediately facilitated based upon the locally stored information regarding such ascertained status.

So configured, considerable flexibility and control can be readily provided with respect to what kinds of content are provided to an end user once general access to an Internet Protocol network has been authorized. Limitations and restrictions with respect to content can be as tight and defined or as loose and general as may best meet the needs and requirements of a given application setting. This, in turn, can permit a corresponding access manager to deploy network-accessing capability to their end user population with considerably reduced concerns regarding potential abuses of that faculty.

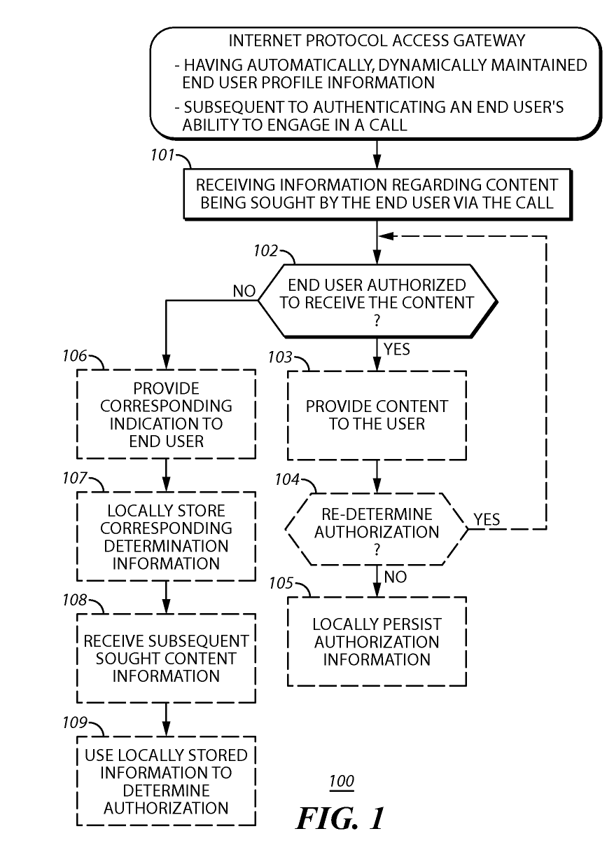

These and other benefits may become clearer upon making a thorough review and study of the following detailed description. Referring now to the drawings, and in particular to FIG. 1, these teachings are useful to employ in conjunction with an Internet Protocol access gateway having an at least partially automatically and dynamically maintained end user profile information. (“Automatic” refers to a non-network management and non-end user style of actuation and includes, for example, profile information updates that are responsive to events and circumstances other than a specific manager/user-initiated update instruction. “Dynamic” refers to a non-static configuration that includes, for example, updates and changes to the profile information as a regular and expected course of action during ordinary operations and not merely when and as, for example, a network manager might enter new otherwise-static value for subsequent usage.)

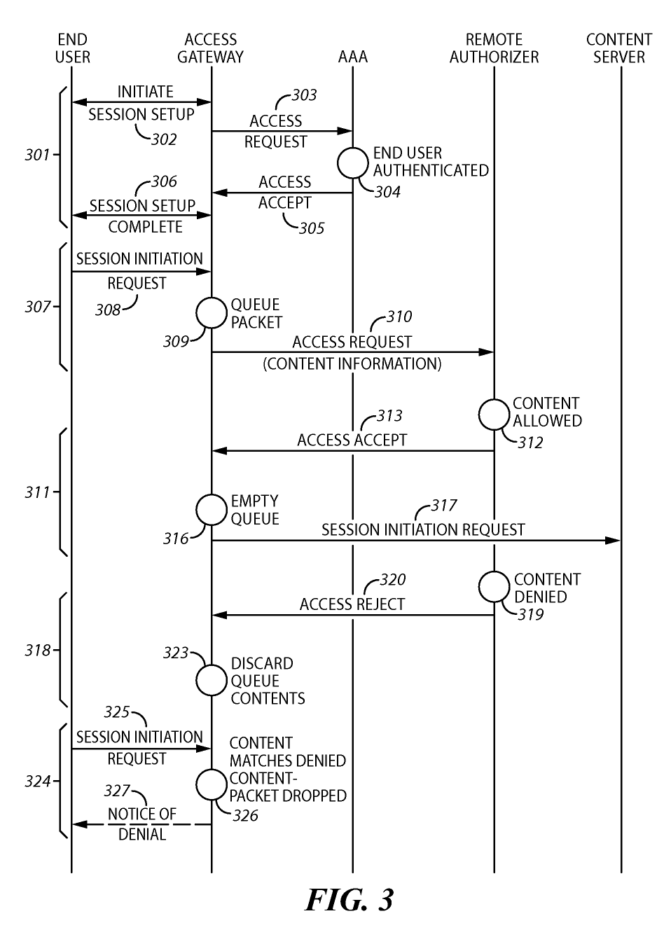

These teachings are also beneficially applied subsequent to a given end user having been authenticated with respect to a corresponding ability to engage in a call. Various ways to effect such authentication are known in the art and these teachings are not particularly sensitive to the selection of any one such approach. By way of illustration and not by way of limitation, and referring momentarily to FIG. 3, an illustrative authentication process 301 can comprise an end user engaging in an initiate session setup message 302 with an access gateway pursuant to which the access gateway transmits an access request 303 to an Authentication, Authorization, and Accounting (AAA) element. The AAA, upon authenticating 304 the end user as per a corresponding authentication criteria and/or process, responds with an access accept message 305. The access gateway, upon receipt of this access accept message 305, then transmits a session setup complete message 306 to the end user to essentially complete this initial authentication of the end user's ability to engage in a call.

Such authorization means, in a traditional sense, that the end user may now access a target network (such as but not limited to the Internet) via the access gateway. As will be well understood by those skilled in the art, the nature of the authorized call can vary with the needs, requirements, and/or limitations of a given application setting. Illustrative call types include, but are not limited to, Hyper Text Transfer Protocol (HTTP) sessions, Session Initiation Protocol (SIP) sessions, and/or File Transfer Protocol (FTP) sessions, to note but a few.

By this approach, the Internet Protocol access gateway receives 101 information regarding content being sought by the end user via the call (that is, content that the end user seeks to receive by way of one or more communication sessions as comprise a part of the previously authenticated call). The information itself can be specific with respect to identifying a particular type of content or can be suggestive of content type rather than specific. Numerous examples of potentially useful content identifiers may be found a RFC 3986 as published by the Internet Engineering TaskForce (IETF) (the contents of which are incorporated herein by this reference). Specific examples of potentially useful content-identifying information include, but are not limited to one or more of:

a destination Internet Protocol address;

an Internet Protocol packet protocol type;

a destination User Datagram Protocol port;

a destination Transmission Control Protocol (TCP) port; and/or

a Uniform Resource Locator (URL) (where those skilled in the art will recognize and understand that a Uniform Resource Locator includes both URL's as such as well as Uniform Resource Names (URN), Uniform Resource Identifiers (URI), and essentially any other type of corresponding identifier.

With momentary reference again to FIG. 3, this step of receiving 101 information regarding content being sought by an end user can comprise, for example, receiving a session initiation request 308 from the end user. Other corresponding actions with respect to session initiation 307 can comprise (by way of illustration and not limitation) having the access gateway queue 309 the corresponding packet(s) and transmit an access request message 310 to a corresponding remote authorizer (as will be described below in more detail).

This access request message 310 can comprise, by one approach, content information as described above as corresponds to identifying the content being sought by the end user. This access request message 310 may also comprise user identification information such as, but not limited to, one or more of:

a user name and/or a domain name as corresponds to the end user;

an International Mobile Station Identity (IMSI);

an Internet Protocol address; and/or

a Uniform Resource Locator (URL) (as characterized above).

Referring again to FIG. 1, this process 100 then provides for determining 102 whether the end user is authorized to receive the indicated content. This determination 102 can comprise, if desired, accessing a local resource (that is, a resource that is integral to the access gateway and/or is otherwise sufficiently physically proximal to the access gateway as to be reasonably considered a local resource) and/or accessing a remote resource. Accessing a local resource will typically entail maintaining local information to inform this determination process. In many cases this may prove overly burdensome and therefore the remote resource approach may be preferred by many system designers and/or administrators.

When accessing a remote resource it may be desirable to not facilitate a communication session via the previously authenticated call prior to determine that the end user is authorized to receive the content. So configured, the access gateway will not take further actions to actually facilitate the communication session that will be used to convey the requested content until corresponding authorization has been confirmed.

Such an approach may, however, lead to some delay with respect to providing an authorized end user with requested content. Therefore, if desired, this process 100 may accommodate at least partially facilitating such a communication session prior to determining that the end user is authorized to receive the content. By one approach the incoming content may be provided to the end user as it becomes available with this flow being halted should subsequent authorization not be forthcoming. By another approach the access gateway arranges to buffer at least part of the incoming content prior to determining that the end user is authorized to receive such content. The access gateway can then facilitate releasing the buffered content to the end user upon receiving the corresponding authorization (or can delete such buffered content upon failing to receive this authorization).

When using a remote authorizer to obtain authorization with respect to providing a given end user with specific content, it is possible that no response may be forthcoming. Such an event might occur for any number of reasons. To accommodate such a circumstance, if desired, this process 100 can further accommodate determining when a timely response has not been received from a remote resource as is expected to provide such authorization tasks and to then responsively employ a local default policy in lieu of such a response.

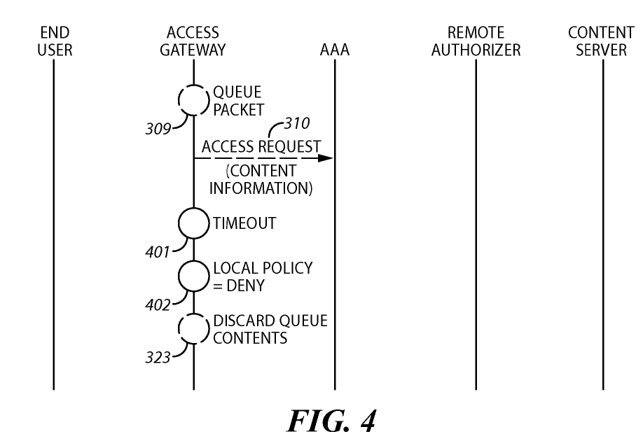

To illustrate such an approach, and referring momentarily to FIG. 4, an access gateway can maintain a count (such as a time-based count) subsequent to sourcing an access request message 310 as earlier described. Upon determining that this count now exceeds some predetermined threshold limit 401, the access gateway can then implement a local policy 402. This local policy can vary as desired. One example local policy may comprise denying the content request and hence denying the end user the session request. Such denial may further provide for discarding 323 queue contents as may have been earlier maintained by the access gateway with respect to specifics of the session request itself.

Other local policies are of course possible. As one example, the local policy may provide for accepting and permitting the requested session and, in turn, permitting access to the requested content. As yet another example, the local policy may vary with other criteria including end user priority, time of day, or such other decision-making criterion as may be selected for use in a given application setting.

Referring again to FIG. 1, by these teachings, this process provides for determining 102 via a determination engine and process of choice, whether to permit and facilitate the presently requested session or not as a function, at least in part, of the content being sought by the end user. When this determination comprising honoring the end user request, this process 100 can provide for providing 103 such content to the end user via, for example, facilitation of the requested communication session.

To illustrate an authorized-content scenario 311 (and without intending to limit the scope of ways by which such facilitation can occur), and referring momentarily again to FIG. 3, a remote authorizer, upon determining to allow 312 the content at issue, can forward an access accept message 313 to the access gateway. The access gateway may then empty its packet queue 316 and employ those contents to now transmit a session initiation request 317 to the corresponding content server (again in accord with prior practice in this regard).

If desired, the content-based authorization described above can be constrained. That is, the authorization itself may be provided with one or more limits with respect to exercise of that authorization. For example, limits may be set with respect to a total duration of time during which the end user may receive the authorized content. As another example, limits may be set with respect to a total quantity of content as may be received by the end user (as measured, for example, by data quantity or some other metric of choice). As yet another example, a limit may exist such that the end user is only to be provided with some, but not all, of the requested content. Other limits may of course be considered. In such a case, this provision 103 of content to the end user can comprise providing the content to the end user in accordance with such limitations as may now correspond to the authorized provided.

Referring again to FIG. 1, if desired, this process 100 can further optionally accommodate re-determining 104 whether the end user continues to have authorization to receive the content. This re-determination 104 can occur when and as desired. Examples include, but are not limited to, making this re-determination during the course of the presently authorized communication session, during the course of the presently authorized call, or subsequent to the present communication session or call. Such an approach might serve, for example, to support an on-going dynamic reassessment regarding continued authorization of the previously requested access.

As another possible option, this process 100 will also permit, if desired, locally persisting 105 information regarding this authorization to receive the content. Such information may be persisted for a period of time of choice. Examples include, but are not limited to, persisting the information regarding authorization subsequent to concluding the present communication session and/or call. Such information, when persisted, may be used, for example, to authorize a subsequent communication request without necessitating remote accessing and/or other local processing as has been described above.

The various steps described above relate to authorization having been granted to receive the requested content. This process 100 will also support, of course, a denial of such authorization. An illustrative denial scenario 318 appears in FIG. 3. When, in this embodiment, the remote authorizer determines to deny the requested content 319, a corresponding access reject message 320 is sent to the access gateway which responds, in this embodiment, by discarding the queue contents 323 as corresponded to the session request by the end user.

Referring again to FIG. 1, if desired, such denial can optionally further comprise providing 106 a corresponding indication to the end user. This indication can comprise text and/or graphic content to inform the end user that the session request and/or content being sought has been denied. This indication can also take the form (or otherwise include), for example, of an address. This address may comprise a link, for example, to a network location where a complete (or more complete) explanation appears as to the basis or nature of the service request denial.

As yet another optional approach, this process 100 can provide for locally storing information that corresponds to the determination to deny provision of the requested content. So configured, if and when the access gateway should receive 108 a repeated end user request for the denied content, this process 100 can then provide for using 109 the locally stored information to recall the previous denial and to now determine that the end user is not authorized to receive this content. That, in turn, can lead to a renewed denial of the request.

An illustrative embodiment of this subsequent denial scenario 324 appears in FIG. 3. In this scenario 324, upon receiving a subsequent session initiation request 325 for the same previously denied content, the access gateway matches 326 the requested content with the denied content locally stored information and proceeds to drop the corresponding packets from the end user (to effectively again deny the content request). If desired, this can further include providing a notice of denial message 327 as described earlier to the end user.

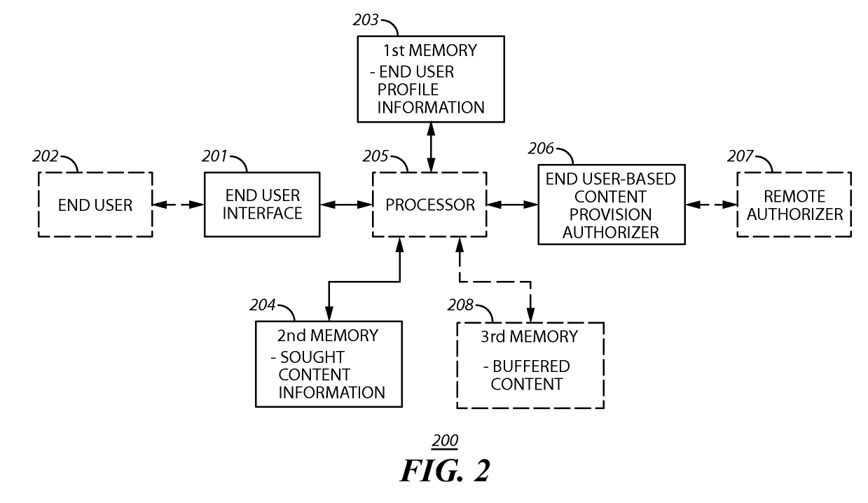

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

This illustrated apparatus comprises an Internet Protocol access gateway 200 such as, but not limited to, a Packet Data Serving Node (PDSN), a Gateway General Packet Radio Service (GPRS) Support Node (GGSN), a mobile Internet Protocol home agent, a dial-up remote access server, a Digital Subscriber Line Access Multiplexer (DSLAM), a Cable Modem Termination System (CMTS), and so forth. Such network elements are well understood in the art and other suitable platforms will no doubt become available in the future.

This access gateway 200 comprises, in this embodiment, an end user interface 201 to facilitate communications with an end user 202 (via an intervening communication fabric of choice). The precise nature of the end user interface 201 will of course vary with the characterizing specifics of the end users 202 themselves. Various end user interfaces are known in the art and, as these teachings are not particularly sensitive to the selection of any particular end user interface, no further elaboration or description regarding such interfaces need be presented here.

This illustrative access gateway 200 also comprises a first memory 203 and a second memory 204 that both operably couple to the end user interface 201 (via, for example, an optional processor 205 of choice). The first memory 203 serves to store automatically, dynamically maintained end user profile information. As the automatic and dynamic obtainment of such end user profile information is well understood in the art, for the sake of brevity no further description will be provided here regarding such end user profile information. The second memory 204 serves, in this embodiment, to store information regarding the content being sought by an already-authenticated end user seeking to engage in a corresponding communication session. This information can be content-identifying information as has already been discussed and described above.

This embodiment also provides for an end user-based content provision authorizer that operably couples to the first and second memories 203 and 204 and to the end user interface 201 as well. If desired, this coupling can optionally occur via the aforementioned processor 205. This end user-based content provision authorizer serves to facilitate the above-described determination regarding whether the end user is authorized to receive the identified content. As noted above, this end user-based content provision authorizer can comprise a local resource that contains the information needed to make this determination. Also as described above, if desired, this end user-based content provision authorizer can comprise, at least in part, a remote authorizer interface that facilitates compatible communications with a remote authorizer 207 such as an authorization server. (Those skilled in the art will understand that such a remote authorizer 207 may essentially be physically located anywhere so long as the access gateway 200 has communication access thereto.)

As noted above, optionally the access gateway can receive and buffer content prior to determining that the end user is truly authorized to receive such content. To facilitate such an approach, the access gateway 200 itself may comprise a third memory 208 to accommodate such buffered content. Those skilled in the art will understand that such buffering could also be fully or partially realized using a storage resource that is external to the access gateway 200 itself if so desired.

So configured, such an apparatus can be readily configured and arranged (via the end user-based content provision authorizer 206 itself and/or the optionally provided processor 205) to effect the various teachings set forth above.

So configured, the content provided to a given end user can be controlled in a highly flexible and scalable manner notwithstanding a preliminary determination that the end user otherwise has authorization to pursue communication sessions as relate to a pre-authorized call. These benefits accrue in a relatively transparent manner with respect to the end user platform; accordingly, there is no particular need to reprogram or alter legacy end user platforms in order to effect these teachings.

Those skilled in the art will recognize and understand that such an access gateway 200 may be comprised of a plurality of physically distinct elements as is suggested by the illustration shown in FIG. 2. It is also possible, however, to view this illustration as comprising a logical view, in which case one or more of these elements (such as the memories) can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an Internet Protocol access gateway having automatically, dynamically maintained end user profile information and subsequent to authenticating an end user's ability to engage in a call:
receiving information regarding content being sought by the end user via the call;
determining whether the end user is authorized to receive the content.

2. The method of claim 1 wherein the Internet Protocol access gateway comprises a Packet Data Serving Node.

3. The method of claim 1 wherein the information regarding content comprises at least one of:
a destination Internet Protocol address;
an Internet Protocol packet protocol type;
a destination User Datagram Protocol port;
a destination Transmission Control Protocol (TCP) port;
a Uniform Resource Locator (URL).

4. The method of claim 1 wherein the call comprises at least one of:
a Hyper Text Transfer Protocol (HTTP) session;
a Session Initiation Protocol (SIP) session;
a File Transfer Protocol (FTP) session.

5. The method of claim 1 wherein receiving information regarding content being sought by the end user via the call comprises receiving a session initiation request from the end user.

6. The method of claim 1 wherein determining whether the end user is authorized to receive the content comprises accessing a local resource to determine whether the end user is authorized to receive the content.

7. The method of claim 1 wherein determining whether the end user is authorized to receive the content comprises accessing a remote resource to determine whether the end user is authorized to receive the content.

8. The method of claim 7 further comprising:
not facilitating a communication session via the call prior to determining that the end user is authorized to receive the content.

9. The method of claim 7 further comprising:
at least partially facilitating a communication session via the call prior to determining that the end user is authorized to receive the content.

10. The method of claim 9 wherein at least partially facilitating a communication session comprises:
buffering at least part of the content prior to determining that the end user is authorized to receive the content to provide buffered content;
providing the buffered content to the end user upon determining that the end user is authorized to receive the content.

11. The method of claim 7 wherein accessing a remote resource comprises providing to the remote resource at least one of:
a user name as corresponds to the end user;
an International Mobile Station Identity (IMSI);
a destination Internet Protocol address;
an Internet Protocol;
a Uniform Resource Locator (URL);
an application type.

12. The method of claim 1 further comprising:
upon determining that the end user is not authorized to receive the content, providing a corresponding indication to the end user.

13. The method of claim 12 wherein the corresponding indication comprises an address.

14. The method of claim 1 further comprising:
upon determining that the end user is not authorized to receive the content, locally storing information corresponding to that determination to provide local information.

15. The method of claim 14 further comprising:
receiving subsequent information regarding the content being again sought by the end user via the call;
using the local information to determine that the end user is not authorized to receive the content.

16. The method of claim 1 wherein determining whether the end user is authorized to receive the content comprises:
accessing a remote resource to determine whether the end user is authorized to receive the content;
upon not receiving a timely response from the remote resource, using a local default policy regarding content access authorization to determine whether the end user is authorized to receive the content.

17. The method of claim 1 further comprising:
when the end user is authorized to receive the content, providing the content to the end user.

18. The method of claim 17 wherein providing the content to the end user further comprises providing the content to the end user in accordance with limitations as correspond to authorization for the end user.

19. The method of claim 18 wherein providing the content to the end user in accordance with limitations as correspond to authorization for the end user comprises providing some, but not all, of the content to the end user.

20. The method of claim 17 further comprising:
locally persisting information regarding authorization to receive the content subsequent to concluding the call.

21. The method of claim 17 further comprising:
re-determining whether the end user continues to have authorization to receive the content during the course of the call.

22. An Internet Protocol access gateway comprising:
a first memory having automatically, dynamically maintained end user profile information stored therein;
an end user interface operably coupled to the first memory;
a second memory having information regarding content being sought by an already-authenticated end user seeking to engage in a communication session;
an end user-based content provision authorizer operably coupled to the first and second memory and the end user interface.

23. The Internet Protocol access gateway of claim 22 wherein the Internet Protocol access gateway comprises a Packet Data Serving Node.

24. The Internet Protocol access gateway of claim 22 wherein the information regarding content being sought by an already-authenticated end user comprises at least one of:
a user name and/or a domain name as corresponds to the end user;
an International Mobile Station Identity (IMSI);
an Internet Protocol address;
a Uniform Resource Locator (URL).

25. The Internet Protocol access gateway of claim 22 wherein the end user-based content provision authorizer comprises means for determining whether the end user is authorized to receive the content.

26. The Internet Protocol access gateway of claim 22 wherein the end user-based content provision authorizer comprises a local resource containing information regarding whether the end user is authorized to receive the content

27. The Internet Protocol access gateway of claim 22 wherein the end user-based content provision authorizer comprises a remote authorizer interface.

28. The Internet Protocol access gateway of claim 22 further comprising:
a third memory operably coupled to the end user-based content provision authorizer and having at least portions of the content buffered therein, such that the content is pre-provisioned prior to determining that the end user is authorized to receive the content.

29. An Internet Protocol access gateway comprising:
a first memory having automatically, dynamically maintained end user profile information stored therein;
means for receiving, subsequent to authenticating an end user's ability to engage in a call, information regarding content being sought by the end user via the call;
means responsive to the means for receiving and the first memory for determining whether the end user is authorized to receive the content.

30. The Internet Protocol access gateway of claim 29 wherein the Internet Protocol access gateway comprises a Packet Data Serving Node.

31. The Internet Protocol access gateway of claim 29 wherein the means for determining whether the end user is authorized to receive the content is responsive to user identification information comprising at least one of:
a user name and/or a domain name as corresponds to the end user;
an International Mobile Station Identity (IMSI);
an Internet Protocol address;
a Uniform Resource Locator (URL).

32. The Internet Protocol access gateway of claim 29 wherein the means for receiving information regarding content being sought by the end user via the call comprises means for receiving a session initiation request from the end user.

33. The Internet Protocol access gateway of claim 29 wherein the means for determining whether the end user is authorized to receive the content comprises means for accessing a local resource to determine whether the end user is authorized to receive the content.

34. The Internet Protocol access gateway of claim 29 wherein the means for determining whether the end user is authorized to receive the content comprises means for accessing a remote resource to determine whether the end user is authorized to receive the content.

35. The Internet Protocol access gateway of claim 34 further comprising:
means responsive to the means for determining for not facilitating a communication session prior to determining that the end user is authorized to receive the content.

36. The Internet Protocol access gateway of claim 34 further comprising:
means for at least partially facilitating a communication session prior to determining that the end user is authorized to receive the content.

37. The Internet Protocol access gateway of claim 36 wherein the means for at least partially facilitating a communication session comprises:
means for buffering at least part of the content prior to determining that the end user is authorized to receive the content to provide buffered content;
means for providing the buffered content to the end user upon determining that the end user is authorized to receive the content.

38. The Internet Protocol access gateway of claim 34 wherein the means for accessing a remote resource comprises means for providing to the remote resource at least one of:
a user name and/or a domain name as corresponds to the end user;
an International Mobile Station Identity (IMSI);
an Internet Protocol address; and/or
a Uniform Resource Locator (URL).

39. The Internet Protocol access gateway of claim 29 further comprising:
means responsive to the means for determining that the end user is not authorized to receive the content for providing a corresponding indication to the end user when the end user is not authorized to receive the content.

40. The Internet Protocol access gateway of claim 29 further comprising:
means responsive to the means for determining for locally storing information corresponding to that determination to provide local information.

41. The Internet Protocol access gateway of claim 40 further comprising:
means for receiving subsequent information regarding the content being again sought by the end user via the call;
means responsive to the means for receiving for using the local information to determine that the end user is not authorized to receive the content.

42. The Internet Protocol access gateway of claim 29 wherein the means for determining whether the end user is authorized to receive the content comprises:
means for accessing a remote resource to determine whether the end user is authorized to receive the content;
means responsive to the means for accessing a remote resource for using a local default policy regarding content access authorization to determine whether the end user is authorized to receive the content upon not receiving a timely response from the remote resource.
